(19) United States
(12) Patent Application Publication
(10) Pub. No.: US 2013/0313224 A1
(43) Pub. Date: Nov. 28, 2013

(54) METHOD FOR FORMING ANTENNA AND COMPRESSION HEAD

(71) Applicant: Wistron NeWeb Corp., Hsinchu (TW)

(72) Inventors: Ching-chia MAI, Hsinchu (TW); Chih-Ching HSU, Hsinchu (TW); Yuan-Chin HSU, Hsinchu (TW); Cheng-Han LEE, Hsinchu (TW)

(73) Assignee: Wistron NeWeb Corp., Hsinchu (TW)

(21) Appl. No.: 13/902,407

(22) Filed: May 24, 2013

(30) Foreign Application Priority Data
May 28, 2012 (TW) 101118917

(51) Int. Cl. B32B 38/14; C23F 1/04; B32B 37/12

(52) U.S. Cl. CPC B32B 38/14; B32B 37/12; C23F 1/04
USPC 216/20; 156/230; 156/233; 156/151; 156/580

(57) ABSTRACT

An embodiment of the invention provides a method for forming an antenna which includes: providing a workpiece having a surface; providing a compression head including a main body, a soft rubber head disposed on the main body, and at least a through-hole, wherein the through-hole penetrates through the main body and the soft rubber head; adsorbing and fixing a conducting film on the soft rubber head through the through-hole; moving the compression head against the surface of the workpiece to press the conducting film onto the surface of the workpiece; removing the compression head; and patterning the conducting film.

### CROSS REFERENCE TO RELATED APPLICATIONS

This Application claims priority of Taiwan Patent Application No. 101118917, filed on May 28, 2012, the entirety of which is incorporated by reference herein.

### BACKGROUND OF THE INVENTION

1. Field of the Invention

The present invention relates to an antenna, and in particular, relates to a method for forming an antenna and a compression head used in the forming of the antenna.

2. Description of the Related Art

There are many limitations when conventional metallization technologies are applied to form antennas. Because the fabrication process is complicated or the electrical impedance is too high, the variety in design of antennas is limited and the efficiency thereof is low.

Recently, because the space and the environmental condition are limited, the antennas of many mobile devices are designed to be on a curved surface or planes which are not coplanar with each other. The conventional technologies such as a printing process and a thermocompression process are only suitable for the application of 2D planar designs. For 3D transfer printing technology, it can only he applied on a curved surface having a high curvature or locations having no interference effect due to interference limitations. In addition, by using a sputtering process or an evaporation process, it is easy for a portion of the formed metal layer to have insufficient thickness due to fabrication process limitations, such that resistance is too high, causing the antenna to have low efficiency.

In order to reduce and/or resolve the problems mentioned above, it is desired to have an improved fabrication process for forming an antenna.

### BRIEF SUMMARY OF THE INVENTION

An embodiment of the invention provides a method for forming an antenna, which includes: providing a workpiece, wherein the workpiece has a surface; providing a compression head, wherein the compression head comprises a main body, a soft rubber head disposed on the main body, and at least a through hole, wherein the through hole passes through the main body and the soft rubber head; adsorbing and fixing a conductive film on the soft rubber head through the through hole; pressing the compression head against the surface of the workpiece to press the conductive film to the surface of the workpiece; removing the compression head; and patterning the conductive film.

An embodiment of the invention provides a method for forming an antenna, which includes: providing a workpiece, wherein the workpiece has a surface; providing a compression head, wherein the compression head comprises a main body, a soft rubber head disposed on the main body, and at least a through hole, wherein the through hole passes through the main body and the soft rubber head; forming a patterned conductive layer on a release film; adsorbing and fixing the release film on the soft rubber head through the through hole; pressing the compression head against the surface of the workpiece, such that the patterned conductive layer on the release film is detached from the release film and sticks to the surface of the workpiece; and removing the compression head and the release film.

An embodiment of the invention provides a method for forming an antenna, which includes: providing a workpiece, wherein the workpiece has a surface; forming a conductive layer on the surface of the workpiece; providing a compression head, wherein the compression head comprises a main body, a soft rubber head disposed on the main body, and at least a through hole, wherein the through hole passes through the main body and the soft rubber head; forming a patterned mask layer on a release film; adsorbing and fixing the release film on the soft rubber head through the through hole; pressing the compression head against the surface of the workpiece, such that the patterned mask layer on the release film is detached from the release film and sticks to the conductive layer on the surface of the workpiece; removing the compression head and the release film; and performing an etching process to remove a portion of the conductive layer so as to pattern the conductive layer by using the patterned mask layer.

An embodiment of the invention provides a compression head, which includes: a main body; a soft rubber head disposed on the main body; and at least a through hole passing through the main body and the soft rubber head.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a cross-sectional view of a compression head according to an embodiment of the present invention;

FIG. 1B is a perspective view of a compression head according to an embodiment of the present invention;

FIGS. 2A-2D are cross-sectional views of a manufacturing process of an antenna according to an embodiment of the present invention;

FIGS. 3A-3D are cross-sectional views of a manufacturing process of an antenna according to an embodiment of the present invention; and

FIGS. 4A-4C are cross-sectional views of a manufacturing process of an antenna according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is understood, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, descriptions of a first layer “on,” “overlying,” (and like descriptions) a second layer, include embodiments where the first and second layers are in direct contact and those where one or more layers are interposing the first and second layers.

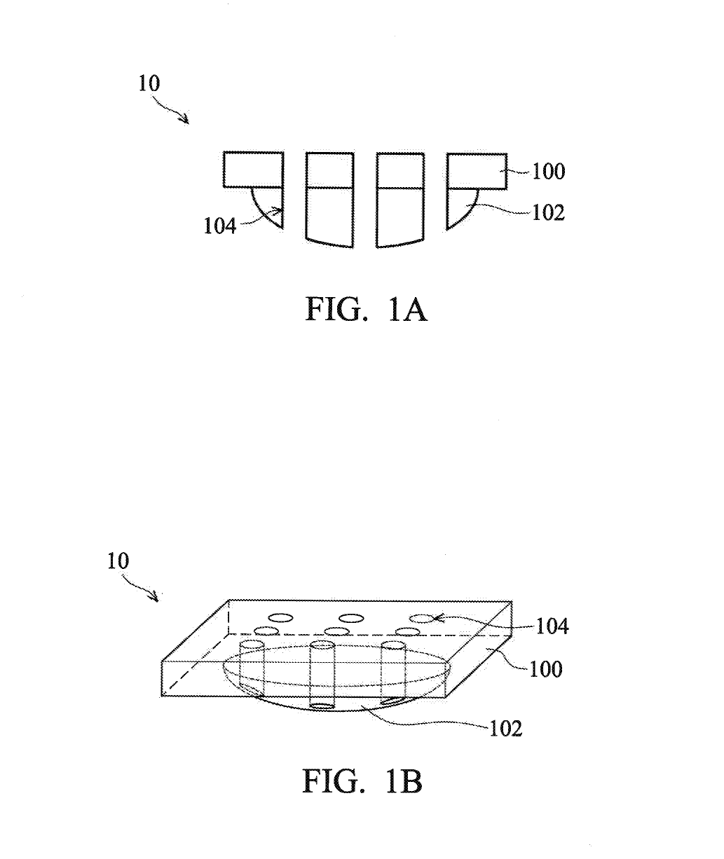

FIG. 1A is a cross-sectional view of a compression head 10 according to an embodiment of the present invention. FIG. 1B is a perspective view of the compression head 10 of FIG. 1A. The compression head 10 of the present embodiment may be, for example, used to form antennas. As shown in FIGS. 1A-1B, the compression head 10 may include a main body 100, a soft rubber head 102 disposed on the main body 100, and at least one through hole 104. The through hole 104 passes through the main body 100 and the soft rubber head 102. In one embodiment, the through hole 104 may be connected to a vacuum system or a gas extraction system (not shown). Thus, the vacuum system or the gas extraction system may apply a suction force at the surface of the soft rubber head 102 through the through hole 104. In one embodiment, a plurality of through holes 104 pass through the main body 100 and the soft rubber head 102. Furthermore, the compression head 10 may include a heating apparatus (not shown). For example, the main body 100 may be connected to a fire brick or other suitable heat conduction devices to raise the temperature of the soft rubber head 102. In one embodiment, the soft rubber head 102 may include, but is not limited to, silicone, Teflon, or the combinations thereof.

In one embodiment, the compression head 10 may be used to form a conductive pattern. For example, the compression head 10 may be used to, but is not limited to, form a suitable conductive pattern on the surface of the workpiece, so as to form antennas.

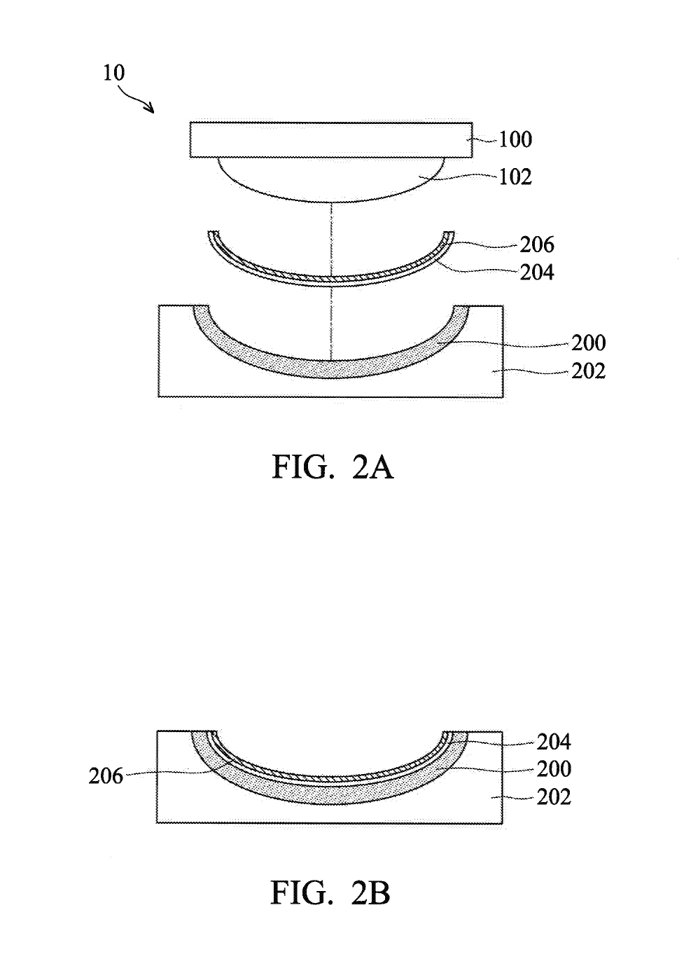

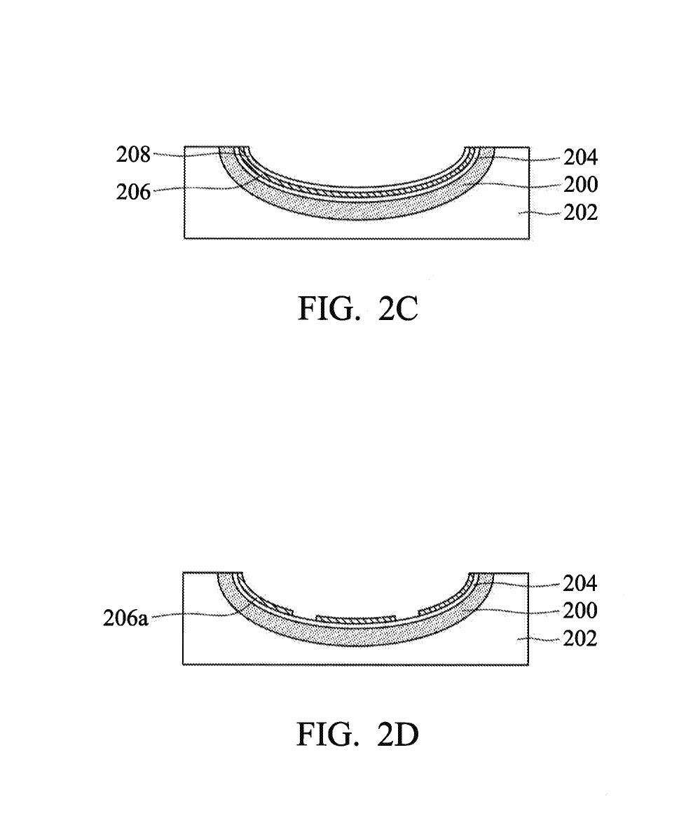

FIGS. 2A-2D are cross-sectional views of a manufacturing process of an antenna according to an embodiment of the present invention, wherein same or similar reference numbers are used to designate same or similar elements.

As shown in FIG. 2A, a workpiece 200 is provided. The workpiece 200 may be, for example, a casing of a cell phone. In one embodiment, the workpiece 200 may be optionally fixed in a fixing device 202 to expose a surface of the workpiece 200. The surface of the workpiece 200 may be a curved surface, such as an inner surface of the casing of the cell phone. Alternatively, the surface of the workpiece 200 may be a convexo-concave surface or an irregular surface.

In one embodiment, the compression head 10, similar to that in FIGS. 1A-1B, is provided, wherein the compression head 10 includes the main body 100, the soft rubber head 102, and the through holes (not shown). Then, the conductive film 206 is adsorbed and fixed on the soft rubber head 102 through the through holes of the compression head 10. The conductive film 206 may include copper foils, aluminum foils, gold foils, tin foils, or the combinations thereof. In one embodiment, an adhesive layer 204 may be optionally disposed on the lower surface of the conductive film 206, such that the conductive film 206 may be stuck on the surface of the workpiece 200 through the adhesive layer 204 in the subsequent process.

Then, the compression head 10 is pressed against the surface of the workpiece 200 to press the conductive film 206 to the surface of the workpiece 200. The soft rubber head 102 of the compression head 10 has elasticity or flexibility, so the stress applied on the surface of the workpiece 200 may be evenly distributed when the conductive film 206 is pressed to the surface of the workpiece 200, which can effectively prevent the fracture and/or the deformation of the workpiece 200. In one embodiment, the workpiece 200 includes brittle materials, such as glass or ceramic materials, etc. The compression head of the present embodiment is adopted to form the conductive pattern on the workpiece, which can effectively prevent the fracture and/or the deformation of the workpiece.

In one embodiment, the conductive film 206 can directly contact the surface of the workpiece 200. In another embodiment, the adhesive layer 204 is disposed on the lower surface of the conductive film 206. In this case, the adhesive layer 204 is sandwiched between the conductive film 206 and the surface of the workpiece 200. In one embodiment, the temperature of the compression head 10 may be increased when the conductive film 206 is pressed to the surface of the workpiece 200. For example, the compression head 10 may be heated, or the temperature of the processing environment may be increased. Then, the compression head 10 may be removed, as shown in FIG. 2B.

Then, the conductive film 206 is patterned to form an antenna. In one embodiment, as shown in FIG. 2C, a photoresist layer 208 may be formed on an upper surface of the conductive film 206. In one embodiment, the photoresist layer 208 is formed on the upper surface of the conductive film 206 by a spray coating process, a spin coating process, or other suitable processes. In another embodiment, the photoresist layer 208 (e.g. a dry film or a circuit protection glue) is adsorbed and fixed on the soft rubber head 102 through the through holes of the compression head 10, which is similar to the method shown in FIG. 2A. Then, the compression head 10 is pressed against the surface of the workpiece 200 to press the photoresist layer 208 to the upper surface of the conductive film 206. Then, a photolithography process is performed to the photoresist layer 208 to pattern the photoresist layer 208 so as to form a patterned photoresist layer. In another embodiment, a laser engraving process may be performed to pattern the photoresist layer 208 on the upper surface of the conductive film 206. The patterned photoresist layer may have openings exposing a portion of the conductive film 206.

Then, the portion of the conductive film 206 which is exposed is removed to pattern the conductive film 206 so as to form a patterned conductive film 206a as shown in FIG. 2D by using the patterned photoresist layer as a mask. Then, the workpiece 200 may be removed from the fixing device 202 to finish forming an antenna.

In the embodiment of FIGS. 2A-2D, the conductive film 206 is patterned after the conductive film 206 is adsorbed and fixed on the soft rubber head 102 through the through holes of the compression head 10, but the invention is not limited thereto. In another embodiment, the conductive film 206 is patterned before the conductive film 206 is adsorbed and fixed on the soft rubber head 102 through the through holes of the compression head 10. For example, the adhesive layer 204 and the conductive film 206 are disposed on a release film (not shown), and the conductive film 206 is patterned, wherein the adhesive layer 204 is an optional element. Then, the adhesive layer 204 and the conductive film 206 are removed from the release film, and the patterned conductive film is adsorbed and fixed and is pressed to the workpiece 200 by the compression head 10, which is similar to the method shown in FIGS. 2A-2B.

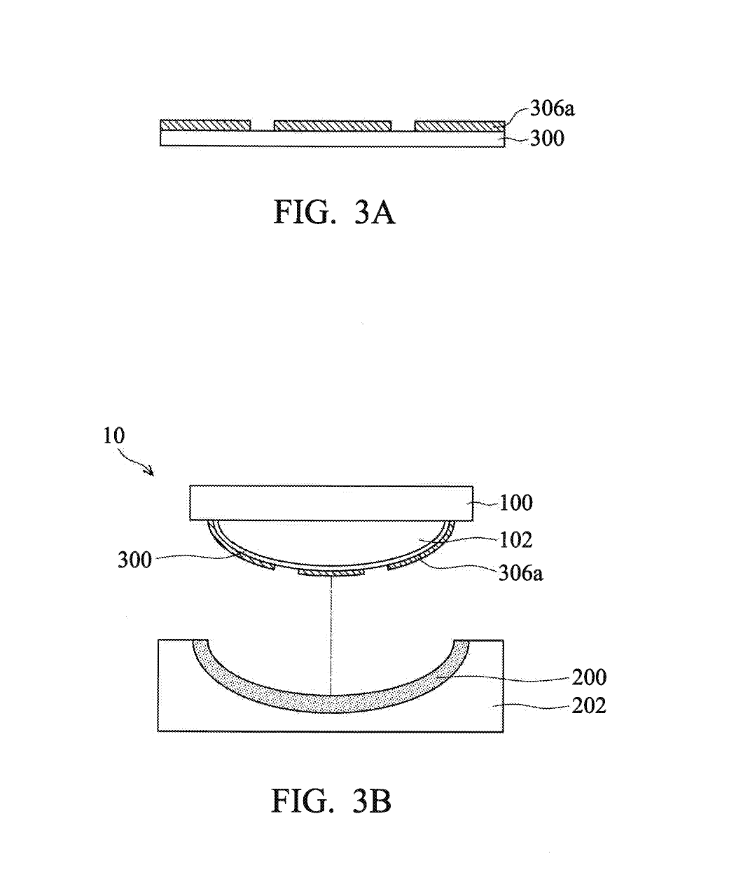

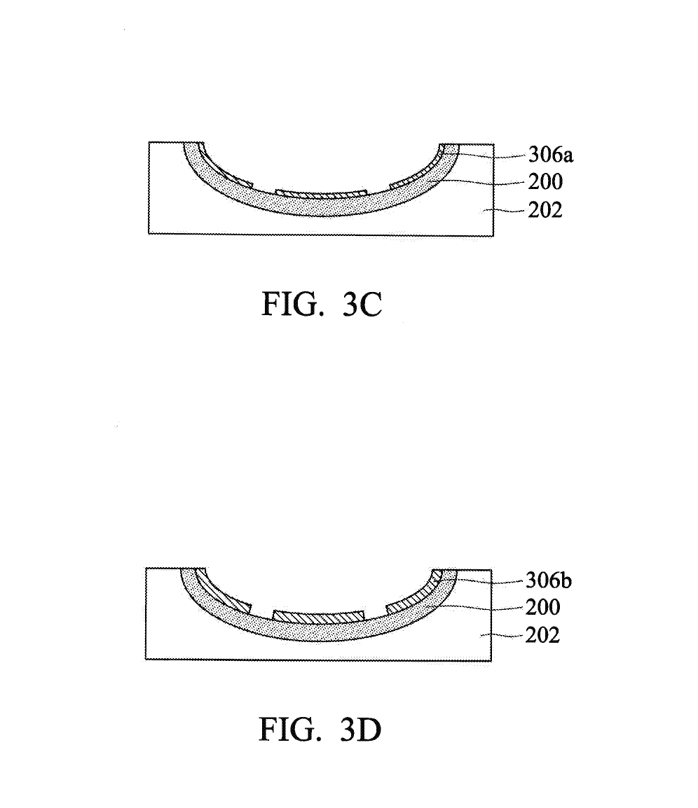

FIGS. 3A-3D are cross-sectional views of a manufacturing process of an antenna according to an embodiment of the present invention, wherein same or similar reference numbers are used to designate same or similar elements.

As shown in FIG. 3A, a patterned conductive layer 306a is formed on a release film 300. In one embodiment, the conductive layer 306a may include a patterned conductive ink. For example, a conductive ink is transferred to the release film 300 to form the patterned conductive layer 306a by performing a printing process and using a transfer film with a specific opening pattern (not shown).

As shown in FIG. 3B, the compression head 10, similar to that of FIGS. 1A-1B, is provided, and the compression head 10 includes the main body 100, the soft rubber head 102, and the through holes (not shown). Then, the release film 300 is adsorbed and fixed on the soft rubber head 102 through the through holes of the compression head 10.

Then, the compression head 10 is pressed against the surface of the workpiece 200, such that a portion of (or a whole of) the patterned conductive layer 306a on the release film 300 is detached from the release film 300 and sticks on the surface of the workpiece 200. In one embodiment, the temperature of the compression head 10 may be increased when at least a portion of the conductive layer 306a is pressed to the surface of the workpiece 200. For example, the compression head 10 may be heated, or the temperature of the processing environment may be increased. Then, the compression head 10 and the release film 300 may be removed to finish forming an antenna, as shown in FIG. 3C.

In one embodiment, a conductive material may be optionally deposited on the conductive layer 306a to increase the thickness of the conductive layer 306a. For example, in one embodiment, an electroplating process and/or a chemical plating process may be performed to deposit a conductive material on the conductive layer 306a on the surface of the workpiece 200 so as to form the conductive layer 306b, as shown in FIG. 3D. Then, the workpiece 200 is removed from the fixing device 202 to finish forming an antenna.

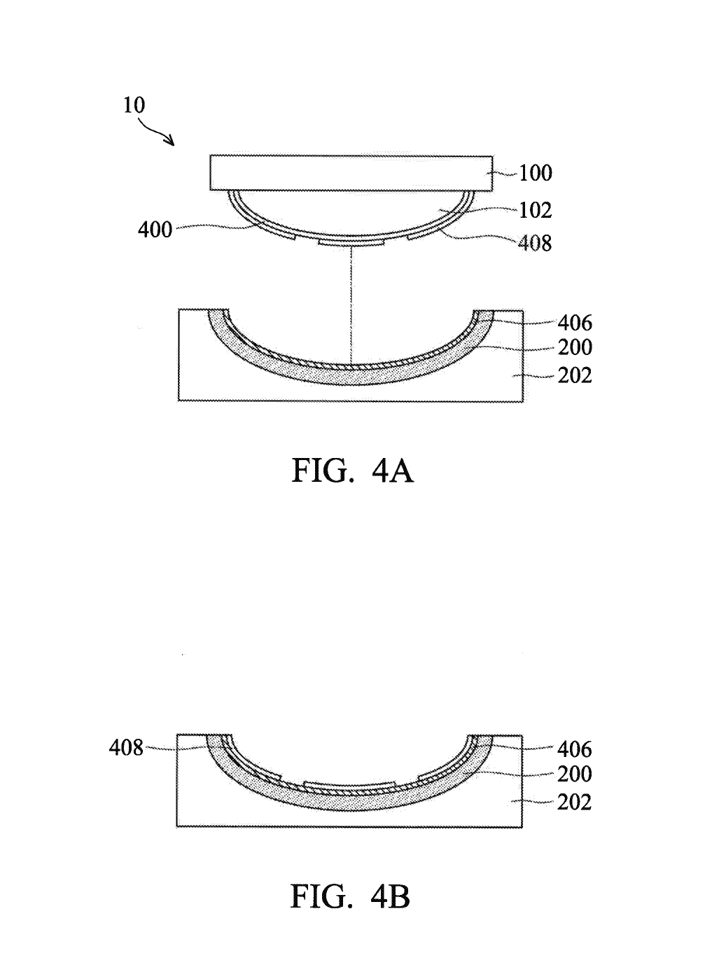

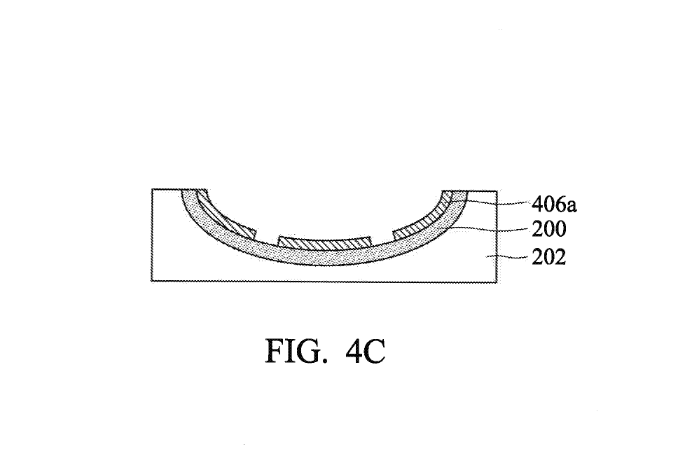

FIGS. 4A-4C are cross-sectional views of a manufacturing process of an antenna according to an embodiment of the present invention, wherein same or similar reference numbers are used to designate same or similar elements.

As shown in FIG. 4A, a workpiece 200 is provided. The workpiece 200 may be, for example, a casing of a cell phone. In one embodiment, the workpiece 200 may be optionally fixed in a fixing device 202 to expose a surface of the workpiece 200 (e.g. an inner surface of the workpiece 200). Then, a conductive layer 406 is formed on the surface of the workpiece 200. For example, a sputtering process or a vapor deposition process may be performed to form the conductive layer 406 on the surface of the workpiece 200. In one embodiment, the conductive layer 406 may substantially cover the whole of the surface of the workpiece 200.

In one embodiment, a patterned mask layer 408 may be optionally formed on the release film 400. In one embodiment, the mask layer 408 may include a circuit protection ink or a photoresist material. For example, a circuit protection ink is transferred to the release film 400 to form the patterned mask layer 408 by performing a printing process and using a transfer film with a specific opening pattern (not shown). Alternatively, a photoresist layer may be formed on the release film 400, and the photoresist layer is patterned to form the patterned mask layer 408 by a photolithography process.

Then, the compression head 10, similar to that of FIGS. 1A-1B, is provided, and the compression head 10 includes the main body 100, the soft rubber head 102, and the through holes (not shown). Then, the release film 400 is adsorbed and fixed on the soft rubber head 102 through the through holes of the compression head 10.

Then, the compression head 10 is pressed against the surface of the workpiece 200, such that a portion of (or a whole of) the patterned mask layer 408 on the release film 400 is detached from le release film 400 and sticks on the conductive layer 406 on the surface of the workpiece 200. In one embodiment, the temperature of the compression head 10 may be increased when at least a portion of the patterned mask layer 408 is pressed to the surface of the workpiece 200. For example, the compression head 10 may be heated, or the temperature of the processing environment may be increased. The patterned mask layer 408 may have openings exposing a portion of the conductive layer 406. Then, the compression head 10 and the release film 400 may be removed, as shown in FIG. 4B.

Then, an etching process is performed to remove the portion of the conductive layer 406 exposed by the patterned mask layer 408 to pattern the conductive layer 406 so as to form the patterned conductive layer 406a, as shown in FIG. 4C. Then, the workpiece 200 is removed from the fixing device 202 to finish forming an antenna.

In one embodiment, after the forming of the patterned conductive layer 406a, the mask layer 408 may be removed depending on application needs, and then an electroplating process or a chemical plating process may be performed to increase the thickness of the patterned conductive layer 406a. Alternatively, if the thickness of the conductive layer 406a is enough, the mask layer 408 may not be removed.

The embodiments of the present invention adopt the specific compression head to form the conductive pattern on the surface of the workpiece, which includes an irregular surface, a convexo-concave surface or a curved surface, etc., to prevent the fracture or the deformation of the workpiece and to form the conductive pattern with a precise pattern and a uniform thickness. The conductive pattern of the embodiments of the present invention may be used as, for example, an antenna.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming an antenna, comprising:
providing a workpiece, wherein the workpiece has a surface;
providing a compression head, wherein the compression head comprises a main body, a soft rubber head disposed on the main body, and at least a through hole, wherein the through hole passes through the main body and the soft rubber head;
adsorbing and fixing a conductive film on the soft rubber head through the through hole;
pressing the compression head against the surface of the workpiece to press the conductive film to the surface of the workpiece;
removing the compression head; and
patterning the conductive film.

2. The method for forming the antenna as claimed in claim 1, further comprising:
forming an adhesive layer on a lower surface of the conductive film, wherein after pressing the compression head against the surface of the workpiece to press the conductive film to the surface of the workpiece, the adhesive layer sticks the conductive film to the surface of the workpiece.

3. The method for forming the antenna as claimed in claim 1, wherein the patterning of the conductive film is performed before adsorbing and fixing the conductive film on the soft rubber head through the through hole.

4. The method for forming the antenna as claimed in claim 1, wherein the patterning of the conductive film is performed after adsorbing and fixing the conductive film on the soft rubber head through the through hole.

5. The method for forming the antenna as claimed in claim 4, wherein the patterning of the conductive film comprises:
after pressing the conductive film to the surface of the workpiece, forming a patterned photoresist layer on an upper surface of the conductive film;
performing an etching process by using the patterned photoresist layer as a mask to remove a portion of the conductive film to pattern the conductive film; and
removing the patterned photoresist layer.

6. The method for forming the antenna as claimed in claim 5, wherein the forming of the patterned photoresist layer comprises:
adsorbing and fixing a photoresist layer on the soft rubber head through the through hole;
pressing the compression head against the surface of the workpiece to press the photoresist layer to the upper surface of the conductive film;
removing the compression head; and
performing a photolithography process to the photoresist layer to pattern the photoresist layer so as to form the patterned photoresist layer.

7. The method for forming the antenna as claimed in claim 5, wherein the forming of the patterned photoresist layer comprises:
adsorbing and fixing a photoresist layer on the soft rubber head through the through hole;
pressing the compression head against the surface of the workpiece to press the photoresist layer to the upper surface of the conductive film;
removing the compression head; and
performing a laser engraving process to the photoresist layer to pattern the photoresist layer so as to form the patterned photoresist layer.

8. The method for forming the antenna as claimed in claim 1, further comprising:
raising a temperature of the compression head when pressing the compression head against the surface of the workpiece.

9. The method for forming the antenna as claimed in claim 1, wherein the surface of the workpiece is a curved surface, a convexo-concave surface, or an irregular surface.

10. The method for forming the antenna as claimed in claim 1, wherein the conductive film comprises copper foils, aluminum foils, gold foils, tin foils, or the combinations thereof.

11. A method for forming an antenna, comprising:
providing a workpiece, wherein the workpiece has a surface;
providing a compression head, wherein the compression head comprises a main body, a soft rubber head disposed on the main body, and at least a through hole, wherein the through hole passes through the main body and the soft rubber head;
forming a patterned conductive layer on a release film;
adsorbing and fixing the release film on the soft rubber head through the through hole;
pressing the compression head against the surface of the workpiece, such that the patterned conductive layer on the release film is detached from the release film and sticks to the surface of the workpiece; and
removing the compression head and the release film.

12. The method for forming the antenna as claimed in claim 11, further comprising:
performing an electroplating process or a chemical plating process to the patterned conductive layer pressed on the surface of the workpiece to deposit a conductive material on the patterned conductive layer.

13. The method for forming the antenna as claimed in claim 11, further comprising:
raising a temperature of the compression head when pressing the compression head against the surface of the workpiece.

14. The method for forming the antenna as claimed in claim 11, wherein the patterned conductive layer comprises a patterned conductive ink.

15. The method for forming the antenna as claimed in claim 14, wherein the patterned conductive layer is transferred to the release film by a printing process.

16. The method for forming the antenna as claimed in claim 11, wherein the surface of the workpiece is a curved surface, a convexo-concave surface, or an irregular surface.

17. A method for forming an antenna, comprising:
providing a workpiece, wherein the workpiece has a surface;
forming a conductive layer on the surface of the workpiece;
providing a compression head, wherein the compression head comprises a main body, a soft rubber head disposed on the main body, and at least a through hole, wherein the through hole passes through the main body and the soft rubber head;
forming a patterned mask layer on a release film;
adsorbing and fixing the release film on the soft rubber head through the through hole;
pressing the compression head against the surface of the workpiece, such that the patterned mask layer on the release film is detached from the release film and sticks to the conductive layer on the surface of the workpiece;
removing the compression head and the release film; and
performing an etching process to remove a portion of the conductive layer so as to pattern the conductive layer by using the patterned mask layer.

18. The method for forming the antenna as claimed in claim 17, further comprising:
removing the patterned mask layer.

19. The method for forming the antenna as claimed in claim 18, further comprising:
performing an electroplating process or a chemical plating process to the conductive layer which is patterned to increase a thickness of the conductive layer.

20. The method for forming the antenna as claimed in claim 17, wherein the mask layer comprises a photoresist layer, a circuit protection ink or the combinations thereof.

21. The method for forming the antenna as claimed in claim 17, wherein the surface of the workpiece is a curved surface, a convexo-concave surface, or an irregular surface.

22. A compression head, comprising:
a main body;
a soft rubber head disposed on the main body; and
at least a through hole passing through the main body and the soft rubber head.

23. The compression head as claimed in claim 22, wherein the soft rubber head comprises silicone, Teflon, or the combinations thereof.
